(19) United States
(12) Patent Application Publication
(10) Pub. No.: US 2006/0204621 A1
(43) Pub. Date: Sep. 14, 2006

(54) Hot cooking liquids absorbing container

(76) Inventor: Arthur W. Piepenbrink, Waterloo, WI (US)

Correspondence Address: Donald J. Ersler, 725 Garvens Avenue, Brookfield, WI, 53005, US

(21) Appl. No.: 11/079,494

(22) Filed: Mar. 14, 2005

(51) Int. Cl. A23B 7/148

(52) U.S. Cl. 426/106

(57) ABSTRACT

A hot cooking liquids absorbing container includes a resealable container and a plurality of absorbing particles. The resealable container is preferably similar in construction to a milk carton, but other types of containers may also be used. An inside surface of the resealable container must be coated to prevent hot liquid fats, oils or suspended greases from leaking out or igniting thereof. The plurality of absorbing particles are preferably fabricated from ground clay, but other materials may also be used. The ground clay must be treated to prevent ignition, from hot cooking liquids. The resealable container is prefilled with the plurality of absorbing particles. A top of the resealable container is opened. Cooking liquids are poured into the resealable container. The absorbing particles absorb the cooking liquids. The top of the resealable container is sealed. The hot cooking liquids absorbing container is then discarded.

### BACKGROUND OF THE INVENTION

1. Field of the Invention

The present invention relates generally to the disposal of cooking liquids and more specifically to a hot cooking liquids absorbing container, which includes absorbing particles that will not ignite when hot liquid fats, oils or suspended greases are poured into a container.

2. Discussion of the Prior Art

There are numerous devices for disposing of hot liquid fats, oils or suspended greases used during cooking. U.S. Pat. No. 4,923,725 to Zafiroglu discloses an article for absorbing cooking grease. The Zafiroglu patent includes a disposable article, suitable for absorbing and immobilizing grease generated during cooking and having a housing containing an absorbent bed of particles and polyolefin fibers. U.S. Pat. No. 4,930,906 to Hemphill discloses a cooking grease disposal bag. The Hemphill patent includes a cooking grease disposal bag formed with a multiple construction and has an inner layer of a heavy gage deformable aluminum foil, and intermediate layer formed by a puncture resistant polyethylene sheet and an outer layer formed by an insulating paper material. U.S. Pat. No. 5,000,341 to Shirota discloses a container with absorbent interior. The Shirota patent includes a container for storage and disposal of liquids, such as liquid fats, oils and suspended greases, comprising a receptacle with interior walls impervious and resistant to such liquids and, contained within the receptacle, material capable of absorbing such liquids.

Accordingly, there is a clearly felt need in the art for a hot cooking liquids absorbing container, which includes a container that will not leak and absorbing particles that will not ignite when hot liquid fats, oils or suspended greases are poured into the container.

### SUMMARY OF THE INVENTION

The present invention provides a hot cooking liquids absorbing container, which includes absorbing particles that will not ignite when hot cooking liquids are poured into the container. The hot cooking liquids absorbing container includes a resealable container and a plurality of absorbing particles. The resealable container is preferably similar in construction to a milk carton, but other types and shapes of containers may also be used. An inside surface of the resealable container must be coated to prevent hot liquid fats, oils or suspended greases from leaking through or igniting the resealable container. The plurality of absorbing particles are preferably fabricated from ground clay, but other absorbent organic or inorganic materials may also be used. The ground clay must be treated to prevent ignition, from hot liquid fats, oils or suspended greases. The resealable container is prefilled with the plurality of absorbing particles. A top of the resealable container is opened. Hot or cold liquid fats, oils or suspended greases are poured into the resealable container. The absorbing particles absorb the liquid fats, oils or suspended greases. The top of the resealable container is sealed. The hot cooking liquids absorbing container is then discarded.

Accordingly, it is an object of the present invention to provide a hot cooking liquids absorbing container, which includes a container that will not leak or ignite, when liquid fats, oils or suspended greases are poured therein.

Finally, it is another object of the present invention to provide a hot cooking liquids absorbing container with absorbing particles that will not ignite when liquid fats, oils or suspended greases are poured into the container.

These and additional objects, advantages, features and benefits of the present invention will become apparent from the following specification.

### BRIEF DESCRIPTION OF THE DRAWINGS

FIG. 1 is a perspective view of a hot cooking liquids absorbing container with a top of a resealable container closed in accordance with the present invention.

FIG. 2 is a perspective view of a hot cooking liquids absorbing container with a top of a resealable container opened in accordance with the present invention.

FIG. 3 is a side cross sectional view of hot liquid fats, oils or suspended greases from a pan being poured into a hot cooking liquids absorbing container in accordance with the present invention.

### DETAILED DESCRIPTION OF THE PREFERRED EMBODIMENTS

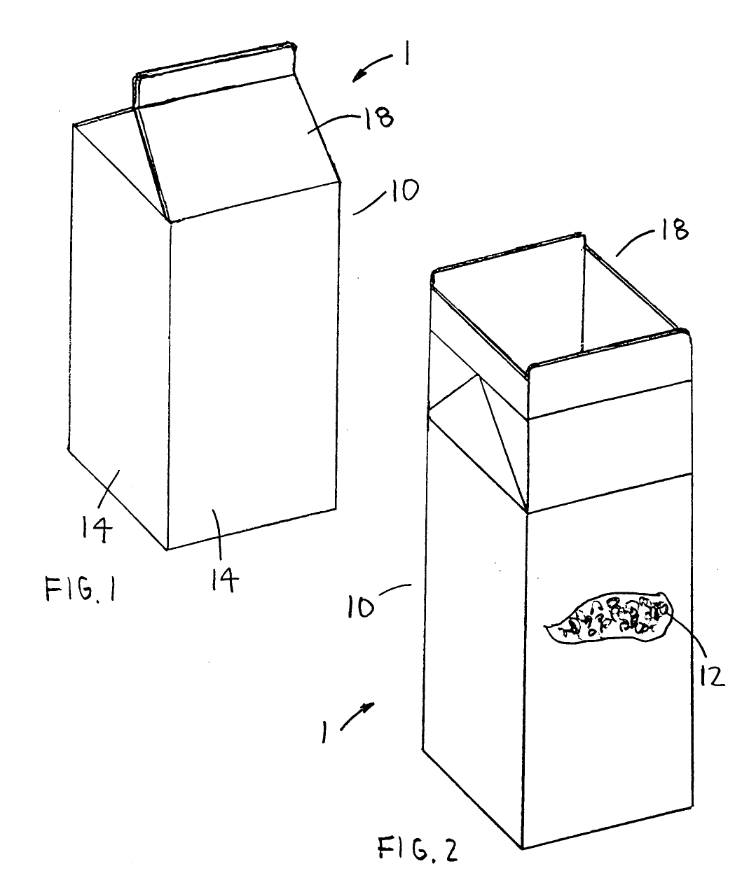

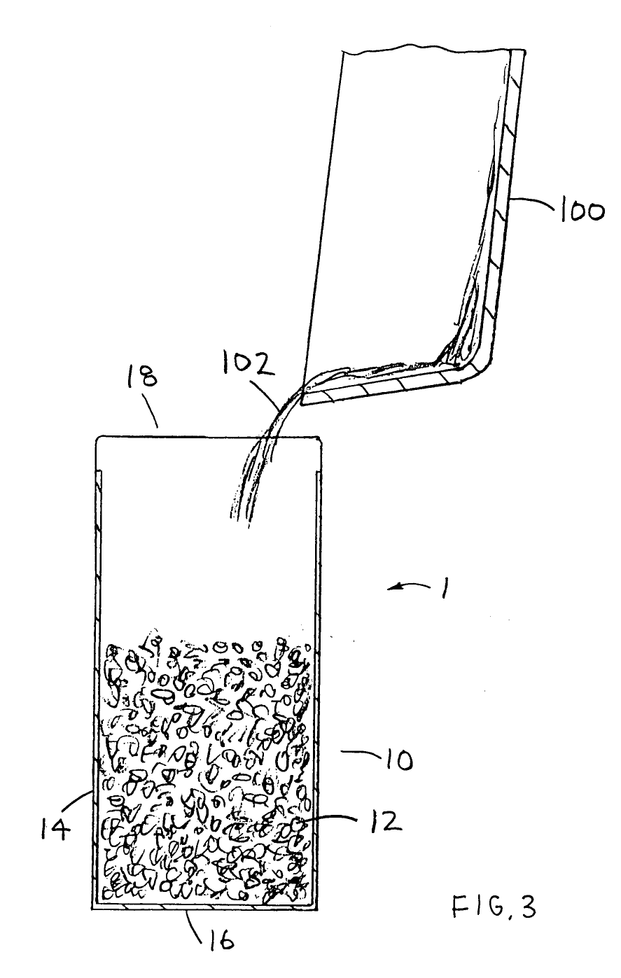

With reference now to the drawings, and particularly to FIG. 1, there is shown a perspective view of a hot cooking liquids absorbing container 1. With reference to FIGS. 2-3, the hot cooking liquids absorbing container 1 includes a resealable container 10 and a plurality of absorbing particles 12. The resealable container 10 is preferably similar in construction to a milk carton, but other types and shapes of containers may be used, such as a container having a round shape and a snap lid. The construction of a milk carton is well known in the art and need not be explained in detail. The resealable container 10 preferably includes four side walls 14, a bottom 16 and a resealable top 18. The resealable top 18 may be the same as a milk carton top or any other suitable shape or design. The resealable container 10 is preferably fabricated from paperboard, but other materials may be used, such as food grade paper. An inside surface of the resealable container 10 must be coated to prevent hot liquid fats, oils or suspended greases from igniting thereof. It is preferably to use a low density polyethylene applied at 610-630 degrees fahrenheit, but other coatings and application temperatures may also be used. Other heat resistant coatings include nylon, silicon oxide and foil.

The plurality of absorbing particles 12 are preferably fabricated from ground clay, but other absorbent organic or inorganic materials may also be used, such as absorbent minerals. The absorbent minerals include attaplugite, bentonite, diatamaceous earth, vermiculite, perlite, pumice, montmorollinite and any other absorbent mineral. The ground clay must be treated to prevent ignition, from hot liquid fats, oils or suspended greases. The ground clay is preferably heat treated to prevent ignition. The heat treatment of the ground clay includes removing the water of hydration. The resealable container 10 is prefilled with the plurality of absorbing particles 12 and the resealable top 18 is then sealed.

The hot cooking liquids absorbing container 1 is preferably utilized in the following manner. The resealable top 18 is opened. Hot or cold liquid fats, oils or suspended greases 102 from a pan 100 or the like is poured into the resealable container 10, through the open resealable top 18. The absorbing particles 12 absorb the hot liquid fats, oils or suspended greases. The resealable top 18 is sealed and the hot cooking liquids absorbing container 1 is then discarded. However, the plurality of absorbing particles 12 may be recycled, after they have been saturated with liquid fats, oils or suspended greases by igniting thereof with a flame in grills, fire places or any other suitable application. The plurality of absorbing particles will burn and leave ash behind.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

I claim:

1. A method of disposing of liquid fats, oils or suspended greases, comprising the steps of:
providing a container having a sealable top, an inside of said container being treated to withstand leakage or ignition from hot liquid fats, oils or suspended greases;
providing a plurality of absorbing particles, said plurality of absorbing particles being able to withstand ignition from the hot liquid fats, oils or suspended greases; and
pouring liquid fats, oils or suspended greases through a top said container.

2. The method of disposing of liquid fats, oils or suspended greases of claim 1, comprising the steps of:
fabricating said container from paperboard, coating an inside surface of said container with a high temperature resistant material.

3. The method of disposing of liquid fats, oils or suspended greases of claim 2, comprising the steps of:
coating an inside surface of said paperboard with a polyethylene.

4. The method of disposing of liquid fats, oils or suspended greases of claim 1, comprising the steps of:
recycling said absorbing particles after they have been saturated with liquid fats, oils or suspended greases by igniting thereof.

5. The method of disposing of liquid fats, oils or suspended greases of claim 1, comprising the steps of:
providing an absorbent organic or inorganic material for said plurality of absorbing particles.

6. The method of disposing of liquid fats, oils or suspended greases of claim 1, comprising the steps of:
providing a ground clay for said plurality of particles.

7. The method of disposing of liquid fats, oils or suspended greases of claim 1, comprising the steps of:
treating with heat said plurality of absorbing particles.

8. A method of disposing of liquid fats, oils or suspended greases, comprising the steps of:
providing a container having a sealable top, said container being fabricated from paperboard, an inside surface of said container being coated with a high temperature resistant material to withstand leakage or ignition from hot liquid fats, oils or liquid greases; and
providing a plurality of absorbing particles, said plurality of absorbing particles being treated to withstand ignition from the hot liquid fats, oils or liquid greases.

9. The method of disposing of liquid fats, oils or suspended greases of claim 8, comprising the steps of:
coating said inside surface of said paperboard with a polyethylene.

10. The method of disposing of liquid fats, oils or suspended greases of claim 8, comprising the steps of:
recycling said absorbing particles after they have been saturated with liquid fats, oils or suspended greases by igniting thereof.

11. The method of disposing of liquid fats, oils or suspended greases of claim 8, comprising the steps of:
providing an absorbent organic or inorganic material for said plurality of absorbing particles.

12. The method of disposing of liquid fats, oils or suspended greases of claim 8, comprising the steps of:
providing ground clay for said plurality of absorbing particles.

13. The method of disposing of liquid fats, oils or suspended greases of claim 12, comprising the steps of:
treating with heat said plurality of absorbing particles.

14. A method of disposing of liquid fats, oils or suspended greases, comprising the steps of:
providing a container having a sealable top, said container being fabricated from paperboard, an inside surface of said container being coated with a high temperature resistant material to withstand leakage or ignition from hot liquid fats, oils or suspended greases; and
providing a plurality of absorbing particles, said plurality of absorbing particles being an absorbent mineral.

15. The method of disposing of liquid fats, oils or suspended greases of claim 14, comprising the steps of:
coating said inside surface of said paperboard with a polyethylene.

16. The method of disposing of liquid fats, oils or suspended greases of claim 14, comprising the steps of:
recycling said absorbing particles after they have been saturated with liquid fats, oils or suspended greases by igniting thereof.

17. The method of disposing of liquid fats, oils or suspended greases of claim 14, comprising the steps of:
treating with heat said plurality of absorbing particles.

18. The method of disposing of liquid fats, oils or suspended greases of claim 14, comprising the steps of:
providing ground clay for said plurality of absorbing particles, said ground clay being an absorbent mineral.

19. The method of disposing of liquid fats, oils or suspended greases of claim 18, comprising the steps of:
removing the water of hydration from said plurality of absorbing particles during the heat treating process.

20. The method of disposing of liquid fats, oils or suspended greases of claim 14, comprising the steps of:
providing an absorbent mineral from the group of attaplugite, bentonite, diatamaceous earth, vermiculite, perlite, pumice and montmorollinite.
